(19) United States
(12) Patent Application Publication
(10) Pub. No.: US 2007/0050426 A1
(43) Pub. Date: Mar. 1, 2007

(54) PLATFORM WITH MANAGEMENT AGENT TO RECEIVE SOFTWARE UPDATES

(76) Inventors: Scott P. Dubal, Hillsboro, OR (US); Douglas D. Boom, Portland, OR (US); Elizabeth M. Kappler, Hillsboro, OR (US)

Correspondence Address: SCHWABE, WILLIAMSON & WYATT, PACWEST CENTER, SUITE 1900, 1211 S.W. FIFTH AVE., PORTLAND, OR, 97204, US

(21) Appl. No.: 11/461,411

(22) Filed: Jul. 31, 2006

Related U.S. Application Data
(63) Continuation-in-part of application No. 11/157,334, filed on Jun. 20, 2005.

(51) Int. Cl. G06F 17/30

(52) U.S. Cl. 707/201

(57) ABSTRACT

In some embodiments, a platform has an active and a dormant state. The platform includes a primary network interface and a mass storage, a management agent having a secondary network interface to receive a software update at least during the dormant state and further having a non-volatile memory to cache the software update; a memory subsystem to contain an updating software agent; a processor, coupled to the memory subsystem, the mass storage, the non-volatile memory and the primary network interface. The processor executes the updating software agent so as to install the software update after the platform transitions from the dormant state to the active state and before the primary network interface is communicatively enabled.

### CROSS-REFERENCE TO RELATED APPLICATIONS

This application is a continuation-in-part of copending U.S. patent application Ser. No. 11/157,334, filed Jun. 20, 2005, entitled “Updating Machines While Disconnected From An Update Source”, and claims priority to the '334 application.

### BACKGROUND

1. Technical Field

Embodiments of the present invention are related to the field of electronic devices, and in particular, to updating platform devices.

2. Description of Related Art

Security and stability concerns related to rapid propagation of viruses, worms, and other intentional and/or unintentionally nefarious code has led to attempts to provide software patches and/or the most current anti-virus software to client platforms from a network administrator over a network. However, client platforms that have left the network during the period of time when updates are sent may not receive the updates. Upon the client platform returning to the network, the network administrator may remotely disconnect the client platform from the network if the proper updates have not been installed in the client platform. In other words, if the client platform has missed receiving the downloaded update, the client platform may be denied access to the network from which it needs to receive an approved update to make the client platform suitable to be connected with the network.

### BRIEF DESCRIPTION OF THE DRAWINGS

FIG. 1 is a block diagram of a communication system, according to some embodiments of the present invention.

FIG. 2 is a flow diagram for the communication system of FIG. 1, according to some embodiments of the present invention, wherein a management agent is implemented using an “always-on” mode of operation.

FIG. 3 is a flow diagram for the communication system of FIG. 1, according to other embodiments of the present invention, wherein the management agent is implemented using an “on-while-dormant” mode of operation.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention. The term “coupled” shall encompass a direct connection, an indirect connection or an indirect communication.

In the following description, terminology is used to discuss certain features of various embodiments of the present invention. For example, a “platform” or “machine” includes hardware and/or software that process information and may encompass a single platform or a system of communicatively coupled platforms, machines or devices operating together. Examples of a platform or a machine may include, but are not limited or restricted to, any of the following processor-based systems: a computer (e.g., a desktop computer, a laptop, a hand-held device, a server, a workstation, etc.); data transmission equipment (e.g., a router, a network hub, a network bridge, a switch, a gateway, a facsimile machine, etc.), wireless equipment (e.g., a cellular base station, a telephone handset, etc.); or a television set-top box. “Software” includes code that, when executed, performs a certain function. “Information” includes one or more bits of data, address, and/or control. A “communications link” includes one or more information-carrying mediums (e.g., electrical wire, optical fiber, cable, bus, or wireless signaling technology). A “network”, which may include parts or all of one or more communication links; may be hardwired, wireless, or a combination of hardwired and wireless; may be a local, metropolitan or wide area computer network; and may be a home network, an intranet or the Internet. “Software update” includes a software patch for changing a pre-existing software program on a platform, a substitute software program for a pre-existing software program on a platform, and/or a new software program that did not previously exist on a platform.

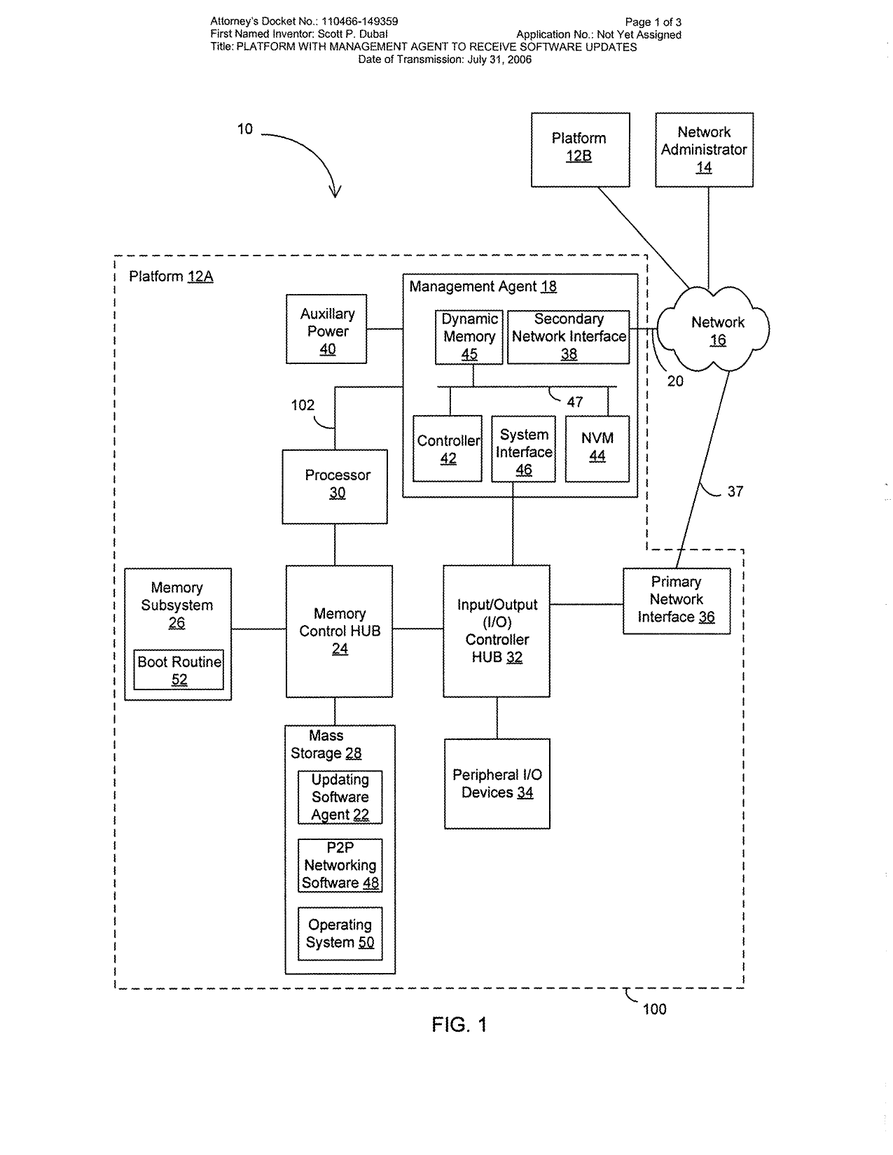

In FIG. 1 there is illustrated a communication system 10, according to some embodiments of the present invention, which includes a plurality of client platforms (“platforms”) 12 and a network administrator 14 in communication with each other via a network 16. For the purposes of simplification, only two platforms 12 (platforms 12A and 12B) are illustrated in FIG. 1, with the physical and logical components of platform 12A being shown in detail in FIG. 1.

As an overview, the platform 12 may include a management agent 18 which caches software updates pushed on the platform 12 over, for example, an out-of-band (OOB) communication channel 20. This caching of software updates by the management agent 18 may occur even though the platform 12 may be in a dormant state. The updates may be automatically installed via an updating software agent 22 the next time the platform 12 boots, which may prevent the platform 12 from being disconnected from the network 16 by the network administrator 14. In some embodiments, peer-to-peer networking may be utilized between the updated platform 12 and one or more out-of-date platforms 12 to provide software updates to the out-of-date platform(s), which may have been disconnected from the network 16 by the network administrator 14. In some embodiments, once updated, the out-of-date platform 12 may gain access to the network 16 again by communicating with the network administration 14 via the OOB communication channel 20 and requesting reinstatement to the network 16. The communication system 10, according to some embodiments of the present invention, will now be described in detail.

In some embodiments, platform 12 may include a memory control hub (MCH) 24; a memory subsystem 26, a mass storage 28, and a processor 30 coupled to the MCH 24; an input/output controller hub (ICH) device 32, peripheral input/output (I/O) devices 34 coupled to the ICH 32; and the management agent 18 coupled to the ICH 32 and the processor 30. Although only one processor 30 is shown, in some embodiments, multiple processors may be used. In some embodiments, the MCH 24 and ICH 32 may not be needed. Although the management agent 18 is shown as a separate component, it may be part of the MCH 24 or the ICH 32. In some embodiments, the platform 12B may have the same components as the platform 12A. These components are merely illustrative of some embodiments of the present invention and other components and arrangement of components are possible.

The platform 12 includes a primary network interface 36 and a secondary network interface 38. More specifically, the platform 12 may include the primary network interface 36 coupled to the ICH 32 and in communications with the network 16 and the management agent 18 may include the secondary network interface 38 in communications with the network 16. In some embodiment, the communications between the management agent 18 and the network administrator 14 may be over the OOB communications channel 20, which may be a communication link forming part of the network 16. In other embodiments, the network interfaces 36 and 38 of the platform 12 may be in communications with different networks. Hence, the primary network interface 36 may be defined as being coupled to a primary communications link 37 and the secondary network interface 38 may be defined as being coupled to a secondary communications link (OOB communications channel) 20. The primary and secondary communication links 37 and 20 may pass through and form part of the same network, as illustrated by network 16 in FIG. 1, or they may pass through and form part of different networks.

In some embodiments, a data rate of the primary communication link 37 may be greater than a data rate of the secondary communications link (OOB communication channel) 20, since the secondary communication link 20 handles network management data traffic, with such traffic including the distribution of software updates. In general, the software updates may be retrieved “in the background” through use of the secondary communication link 20, whereas the primary communication link 37 may have a higher throughput used for general network communications. In summary, the communications links 20 and 37 may differ as to the type of link and may be part of different networks. For example, in one embodiment, the secondary communication link 20 may a slower wireless link and the primary communication link 37 may be a faster wired link.

In some embodiments, the management agent 18 may be implemented as a network interface card (NIC). This NIC, also commonly referred to as a network adaptor, may be low power NIC or may be a NIC with a low-power state. In some embodiments, the management agent 18 may be coupled to an auxiliary (AUX) power source 40. For example, NIC may have an AUX power plug on a NIC board, so that a chipset/motherboard may power the secondary communication link (OOB communications channel) 20.

In some embodiments, the management agent 18 may include a controller 42, a non-volatile memory (NVM) 44, a dynamic memory 45, a system interface 46, and the secondary network interface 38, all coupled together by way of an agent bus 47. In some embodiments, the non-volatile memory 44 may be flash or EEPROM (electrically erasable programmable read only memory) and may be used for storing the software updates. In some embodiments, the controller 42 may be a processor for performing network management functions, including receiving and caching software updates, as will be described hereinafter. In other embodiments, the controller 42 may be a programmable or non-programmable logic device or array or an application specific integrated circuit.

In some embodiments, the management agent 18 may execute a network circuit breaker routine to undertake to disconnect the primary network interface 36 from the network 16 in response to a disabling circuit breaker signal or to connect the primary network interface 36 to the network 16 in response to an enabling circuit breaker signal. In some embodiments, the disabling and enabling circuit breaker signals may be received by the management agent 18 from the network administrator 14 by way of the secondary network interface 38. Hence, this network circuit breaker function is under the control of the network administrator 14.

In some embodiments, the mass storage 28 may store the updating software agent 22, peer-to-peer (P2P) networking software 48, and an operating system (OS) 50, all of which may be moved to the memory subsystem 26 for execution by the processor 30. In this embodiment, the updating software agent 22 may be called by a boot routine 52, which may be part of the memory subsystem 52, as will be described hereinafter. In another embodiment, the software agent 22 may be part of a boot routine 52 stored in the memory subsystem 26. The P2P networking software 48 may use any one of a number of peer-to-peer protocols that are suited to transferring software updates from one platform 12 to another platform 12, as will be described hereinafter.

In some embodiments, the management agent 18 may receive software updates from the network administrator 14 over the OOB communication channel 20, store/cache the software updates (e.g., update capsules) in the non-volatile memory 44, and perform asset inventories, even though the platform 12 is turned off, the operating system 50 has locked up or the mass storage 28 has failed. This may be accomplished by the management agent 18 being implemented as a subsystem, completely separate from the host operating system 50 executed by the processor 30. The management agent 18 may connect with compatible management and security software of the network administrator 14 via the secondary network interface 38.

In some embodiments, the network administrator 14 may implement on-connect policies that are applied to the connecting platforms 12 (e.g., platforms 12A and/or 12B) in order to validate their state (e.g., whether they have the latest software updates) before they are allowed onto (connect to) the network 16. For example, a security policy of the network administrator 14 may be implemented at the platform 12 by undertaking an inventory assessment of the current software on the platform 12 to determine if the current software on the platform 12 is updated. If updated, then the network administrator 14 may allow the platform 12 to communicate with the network 16. If the platform 12 has missed receiving the downloaded update, the platform 12 may be denied access to the network 16. In some embodiments, the network administrator 14 may be operated by an information technology (IT) department of an organization, such IT department being responsible for updating the platforms 12 with software updates.

The platform 12 may be defined to have a dormant state wherein the primary network interface 36 is not connected to the network 16 and an active state wherein the primary network interface 36 is operationally connected to the network 16. The dormant state of the platform 12 may result from a number of conditions, such as when the platform 12 is removed from the network 16 by powering it off, entering a low-power or no-power state, entering an idle state, losing network connectivity through the primary network interface 36, turning off a transceiver of the primary network interface 36, etc. Also, as mentioned above, the platform 12 may be placed in the dormant state by the previously-described circuit breaker function, which may be under the control of the network administrator 14.

In some embodiments, regardless of the active or dormant state of the platform 12, the secondary network interface 38 may remain enabled so that the management agent 18 may be coupled to the network administrator 14 or a peer source (to be described hereinafter) via the OOB communication channel 20 to receive the software updates. In other words, the management agent 18, as long it has power, may have an “always on” mode, even when the platform 12 is dormant (e.g., powered down). Therefore, the management agent 18 may use the dedicated non-volatile memory 44 for caching all of the software updates capsules that the network administrator 14 has uploaded/pushed onto the platforms 12, regardless of whether the platform 12 is in its dormant state. These embodiments of the management agent 18 will be referred to as having an “always on” mode of operation.

In alternative embodiments, the management agent 18 may be powered on when the platform 12 transitions from its active state to its dormant state, since it is during the dormant state when updates received via the primary network interface 36 would otherwise be missed. The secondary network interface 38 would not have an “always on” mode and updates sent while the platform 12 is powered on (active state) would be received by the primary network interface 36. In these embodiments, upon the platform 12 transitioning from its dormant state to its active state (powered up), the management agent 18 may remain on for a sufficiently long enough time period that the updating software agent 22 may check the NVM 44 for updates received and to install such updates (or at least move them to the memory subsystem 26 for subsequent installation). These alternative embodiments of the management agent 18 will be referred to as having “on-while-dormant” mode of operation, even though the management agent may be on for this additional period of time after the platform enters its active state.

With respect to the previously mentioned P2P connection to provide software updates between peer platforms 12, in the communication system 10 one platform 12 (e.g., platform 12A) may be have updated software (“updated platform”) with the latest software updates, with such updated platform 12 being updated via the network 16. In the communication system 10, there may be one or more platforms (e.g., platform 12B) that are missing one or more software updates. If the platform 12 is missing one or more software updates, then this platform 12 may be referred to as an “out-of-date platform”.

In some embodiments, the software updates in the updated platform 12 may be moved by the updating software agent 22 from the NVM 44 to the memory subsystem 26 for installation, as will be described later. Thus, the software updates, available in the memory subsystem 26, may be transmitted, with the assistance of the P2P networking software 48, through the primary network interface 36 of updated platform 12 to the secondary network interface 38 of the out-of-date platform 12. In alternative embodiments, the software updates may be transmitted through the secondary network interface 38 of the updated platform 12 to the secondary network interface 38 of the out-of-date platform 12, under the control of the P2P networking software 48 and the management agent 18. With this peer-to-peer networking, the updated platform 12 essentially takes the role of the network administrator 14 in providing the software updates.

With respect to the previously-described “always-on” mode of operation of the management agent 18, an example of how the platform 12 may become “out-of-date” is when the management agent 18 may have not been powered on (not enabled) when a software update was sent by the network administrator 14 (regardless of whether the platform is in its dormant or active state). Another example is where the OOB communication channel 20 fails when the software update is transmitted by the network administrator 14, even though the management agent 18 is enabled. In turn, the failure to receive the software update may have caused the network administrator 14 to disconnect the out-of-date platform 12 from the network 16 by way of the circuit breaker routine executed by the management agent 18. Hence, the updated platform 12 subsequently may serve as an update source for the out-of-date platform 12, once the management agent 18 is powered up or the channel 20 is restored for the out-of-date platform 12 and even after the out-of-date platform 12 has been disconnected from the network 16. Once updated, the platform 12 may use its OOB communication channel 20 to request that the network administrator 14 reinstate the platform 12 to the network 16 by sending an enabling circuit breaker signal. Once the out-of-date platform 12 reestablishes its status as a updated platform 12, it may act as a peer source for other out-of-date platforms 12.

With respect to the previously-described “on-while dormant” mode of operation of the management agent 18, while the platform 12 is in its dormant state, the above examples for causing the platform 12 to be out-of-date also would be applicable. When in the active state, then the platform 12 may become out-of-date if it fails to receive an update via the primary network interface 36.

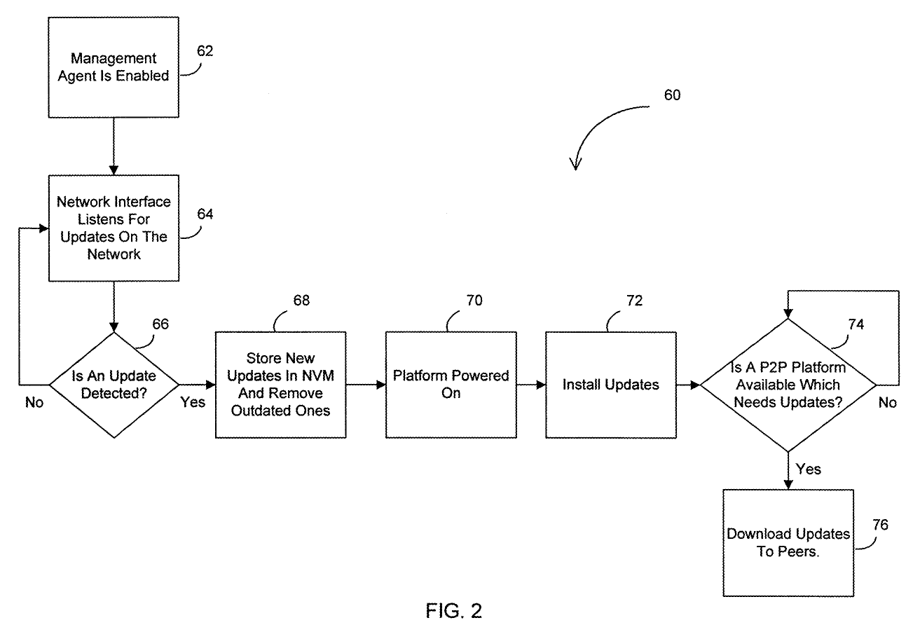

Referring to FIG. 1 and a flow diagram of FIG. 2, a process 60 for the platform 12 is now described, according to one embodiment of the present invention. The process 60 of the flow diagram of FIG. 2 is for the management agent 18 when it is implemented in the previously described “always on” mode of operation. Additionally, the process 60 shown in FIG. 2 is for updates received while the platform 12 is in its dormant state. However, the process during active state of the platform 12, although not shown in FIG. 2, will also be described when it differs.

In an operation 62, the management agent 18 of the platform 12 is enabled and coupled to the OOB communication channel 20 via the secondary network interface 38. When the management agent 18 is implemented with its previously-described “always on” mode of operation, the platform 12 may be in its dormant state (e.g., system off) or active state (e.g., system on), but the management agent 18 is in its enabled state, as previously described. A transition between the dormant state and active state of the platform 12 (e.g., system) does not affect the management agent 18 being in its enabled state. When the management agent is in its enabled state, it may receive power from its auxiliary power source 40.

In an operation 64 of FIG. 2, the process 60 may use the management agent 18 to start “listening” for software updates provided over the OOB communication channel 20. In some embodiments, the software updates may be from the network administrator 14 via a server-client relationship. In other embodiments, the updates may come from the network administrator 14 via a server-client relationship and/or may come from other platforms 12 via a peer-to-peer relationship, as previously described. When in this listening or monitoring mode, each time a software update (e.g., software capsule) is pushed on the platform 12, the secondary network interface 38 may receive one or more packets from the network 16 for a software patch and/or may receive packets for an entire software module or program.

In an operation 66 of FIG. 2, the process 60 may use the management agent 18 to determine whether a software update has been received. If a software update is not detected, then the process 60 loops back to the operation 64. If a software update is detected, then the process 60 advances to an operation 68 of FIG. 2.

In an operation 68 of FIG. 2, the process 60 may use the management agent 18 to queue up and store the received software updates in the NVM 44. Additionally, in some embodiments, if there are any out-of-date updates stored on the NVM 44, these may be deleted. For example, an unapplied update cached in the NVM 44 may be replaced with a newer update received over the network 16. In general, in the case of the platform 12 being in its dormant state, the software updates may be cached in the NVM 44 pending return of the platform 12 from its dormant state. Generally, the software updates may be retained at least until they are installed after the transition of the platform 12 from its dormant state to its active state, and this installation needs to occur before the primary network interface 36 is communicatively enabled to communicate with the network 16.

In some embodiments, the update may be discarded from the NVM 44 after installation. In other embodiments, the updates may be retained after installation so that they may be used for peer-to-peer updating, to be described hereinafter, and then they may be discarded. In some embodiments, the updates may be discarded only if there is not enough room to store new updates on the NVM 44. In other embodiments, the software updates may be moved from the NVM 44 to the memory subsystem 26 for subsequent downloading to out-of-date platforms 12; hence, they do not need to be retained in the NVM 44 for this peer-source purpose.

In an operation 70 of FIG. 2, the process 60 may power on the platform 12 (system). More specifically, the platform 12 boots up using the boot routine 52. The boot routine 52 may include basic input/output system (BIOS) or boot loader code which is executed by the processor 30. The boot routine 52 may test hardware setup, may start the operating system 50, and may support the transfer of data among hardware devices.

In an operation 72 of FIG. 2, the process 60 may use the updating software agent 70 to check the NVM 44 for updates. To access the MVM 44, the updating software agent 22 needs to know where the NVM 44 is mapped in system memory (memory subsystem 26). In some embodiments, if the NVM 44 is an EEPROM, it may be read via calls to the operating system (OS) kernel's memory read/write routines by using an OS vendor-supplied driver.

If the updating software agent 70 finds uninstalled updates in the MVM 44, then operation 72 of process 60 installs the updates. Installation of the software updates need to be accomplished before the platform 12 is connected to the network 16 by way of the primary network interface 36. In other words, the software updates need to be installed before the primary network interface 36 is enabled and before the platform 12 is logged onto the network 16. After the software is updated, communications with the network administrator 14 may be undertaken without the platform 12 being disconnected by the network administrator because of not having the proper updates.

In other embodiments, the boot routine 52 may be modified so that prior to loading part or all of the operating system 50, the boot routine 52 may load the updating software agent 22 into the subsystem memory 26 from the mass storage 28 for execution by the processor 30. The updating software agent 22, upon being executed, may check for software updates in the NVM 44, and may install any located the software updates. In these embodiments and like embodiments, the platform 12 may be considered to have transitioned from its dormant state and entered its active state when the boot code has been executed to the point of being of able to load the software agent 22, even though all or part of the operating system 50 has not yet been loaded. In other embodiments, the updating software agent 22 may be made part of the boot routine 52 and stored in non-volatile memory of the subsystem memory 26, as will be described in more detail hereinafter.

With respect to any updates received while the platform 12 is in its active state, the operation system 50 may be interrupted to install them or the updates may be installed the next time the system boots in the manner described above. Suitable interrupt mechanisms for the management agent 18 will be discussed later.

In some embodiments, an operation 74 of the process 60 of FIG. 2 may be undertaken. In the operation 74, the peer-to-peer (P2P) networking software 48 may be loaded into the memory subsystem 26 of an updated platform 12 to undertake a search for out-of-date platforms 12 for which not all of the proper updates have been received. Upon locating a platform 12 via the network 16, the P2P networking software 48 may establish a peer-to-peer connection with the platform 12 and determine if the located platform 12 is an out-of-date platform 12. In some embodiments, the updated platform 12, using the P2P networking software 48, may merely determine that the network administrator 14 has disabled the located platform 12, thereby inferring that the platform 12 is out-of-date. In other embodiments, the updated platform 12 may do an inventory assessment to determine that the located platform 12 is out-of-date. In some embodiments, the P2P networking software 48 may locate a number of platforms 12 by repeating its search until no other out-of-date platforms 12 are located that need updates.

In an operation 76 of process 60, when connected to the out-of date platform(s) 12, the P2P networking software 48 may download the updates to those platform(s) 12 that are determined to be out-of-date. In some embodiments, the updated platform 12 may take all of its updates previously located by the updating software agent 22 in the NVM 44 and download these updates to the out-of-date platforms 12. In some embodiments, this presupposes that such updates have not been deleted when they were installed on the updated platform. After the software updates have been downloaded to the out-of-date platforms 12 via the peer-to-peer connection, they may be deleted from the NVM 44. In other embodiments, the updates may have been saved in the memory subsystem 26 for downloading, eliminating the need to retain them in the NVM 44.

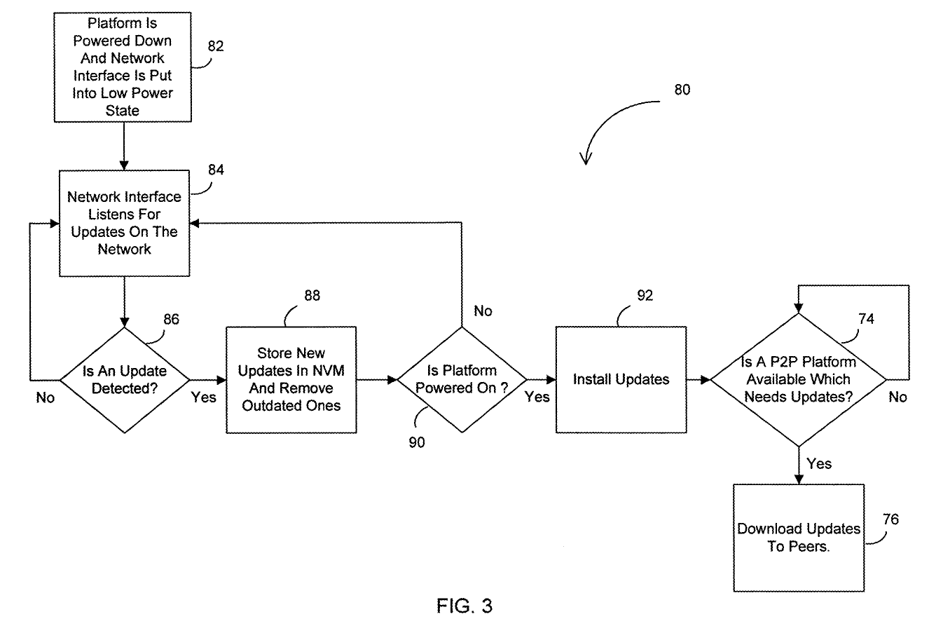

Referring to FIG. 1 and a flow diagram of FIG. 3, a process 80 for the platform 12 is now described, according to another embodiment of the present invention. The process 80 of the flow diagram of FIG. 3 is for where the management agent 18 is implemented in the previously described “on-while dormant” mode of operation. The discussion of the process 80 primarily will focus on those operations that differ from the operations of process 60 of FIG. 2 and those operations that are the same as in FIG. 2 will retain the same reference numbers and will not be described again.

In an operation 82 of the process 80 of FIG. 3, the platform 12 may be powered down from its active state to its dormant state. When in the dormant state, the secondary network interface 38 may be put into its low power state (enabled) to receive software updates, after having been turned off in the active state. In other words, the management agent 18 may be turned on in the dormant state. When the platform is in its dormant state, the secondary network interface 38 may be connected to the network 16 and may be used to receive the software updates, while the primary network interface 36 may be disabled and may not be connected to the network 16.

In an operation 84, the process 80 may use the management agent 18 to start “listening” for software updates provided over the OOB communication channel 20. In an operation 86, the process 80 may use the management agent 18 to determine whether a software update has been received. If a software update is not detected, then the process 80 loops back to the operation 84. If a software update is detected, then the process 80 advances to an operation 88. In an operation 88, the process 80 may use the management agent 18 to queue up and store the received software updates in the NVM 44. Deletions of updates may occur as described with process 60 of FIG. 2.

In an operation 90, the process 80 asks whether the platform 12 is powered on. In other words, the process 80 asks whether the platform has transition from its dormant state to its active state. If the platform 12 is now in its active state, then the process 80 proceeds to the operation 74. If the platform 12 remains in its dormant state, then the process 80 loops back to the operation 84 and continues to listen or monitor for updates. When the platform 12 is powered on to its active state, the primary network interface 36 may be used to receive the software updates and the secondary network interface 38 may be disabled.

In the operation 92, the software updates may be installed with the updating software agent 22. In some embodiments, the management agent 18 may stay on for a long enough period after the platform 12 becomes active (system turned on) that the updating software agent 22 may access the software updates from the NVM 44. Thereafter, the management agent 18 may be turned off until the next time until the platform 12 is powered down in the operation 82.

The subsequent operations 74 and 76 for peer-to-peer distribution of the software updates is the same as previously described with respect to FIG. 2; hence, these operations will not be described again.

Referring to FIG. 1, previously described components of the platform 12, according to some embodiments of the present invention, are now described in more detail with some illustrative examples. However, these examples are not intended to be limiting to the scope of the claims, and other components and arrangement of components may be used.

In some embodiments, the management agent 18, as previously mentioned, may be implemented as a low-power network adapter. For example, the management agent 18 may be implemented as a wireless adapter when the network 16 is a wireless network. In some embodiments, the network adapter may be a plug-in module that would go into an expansion port of the platform 12, such as a spare drive bay, or may be plug into a spare mini-PCI (peripheral computer interface) slot.

In some embodiments, the management agent 18 may be adapted to catch all special update packets, such as broadcast packets and Microsoft® push packets using the Microsoft® System Management Services (SMS). In some embodiments, the peer-to-peer software may use Advanced Peer to Peer Networking (APPN) protocol, Windows™ peer-to-peer network protocol or other suitable peer-to-peer networking protocols. In some embodiments, security and validity of install updates may be determined either by a method built into the update, or by going onto the network to validate the updates.

In some embodiments, the memory subsystem 26 may include any type of memory to be used with the platform 12 and may contain multiple memories including both volatile and non-volatile memories. Examples of volatile memory of the memory subsystem 26 may include, but are not limited to, a dynamic random access memory (DRAM), a static random access memory (SRAM), etc. or any combination thereof and so forth. In some embodiments, the memory subsystem 26 may also include the non-volatile memory for the previously-described boot routine 52. For example, the previously-described boot routine 52 may be stored in a read only memory (ROM), programmable memory (PROM), erasable programmable memory (EPROM), flash memory or like non-volatile memory, so that the boot routine 52 may be executed by the processor 30 to boot up the platform 12. As previously described, in some embodiments, the boot routine 52 may load the updating software agent 22 into the memory subsystem 26 from the mass storage 28. In other embodiments, the boot routine 52 may include the updating software agent 22; hence, in these embodiments, the updating software agent may be stored in the non-volatile memory forming part of the memory subsystem 26.

Examples of the non-volatile mass storage 28 may include, but are not limited to, a hard disk drive, a compact disk drive (CD), a digital versatile disk driver (DVD), a floppy diskette, a tape system and so forth. In some embodiments, the processor 30, chipset having the ICH 32 and MCH 24, memory subsystem 26, mass storage 28 may be mounted on a system motherboard 100 in the platform 12.

In some embodiments, the network connection for management agent 18 through the secondary network interface 38 may be independent of the operating system 50 executed by the processor 30. All remote management traffic to and from the management agent 18 may be communicated even in the absence the operating system 50. The controller 42 may host a network management stack to support the out-of band communications over the OOB communication channel 20. Although the management agent 18 is shown as a separate component, alternatively it may be a part of the MCH 24 or the ICH 32.

In some embodiments, the controller 42 may access code from the non-volatile memory 44 and may move it to the dynamic memory 45 for execution. The dynamic memory 45 may be coupled with the agent bus 47, so that the dynamic memory 45 may provide storage for instructions and/or data to be used during operation. The non-volatile memory 44 may be coupled with agent bus 47 and may be used to store static data and/or instructions, in addition to the cached updates. The controller 42 may be coupled with agent bus 47 and may perform control operations and/or execute instructions provided by the dynamic memory 45 and/or non-volatile memory 44. In some embodiments, the ICH 32 may be coupled with the management agent 18 by way of the system interface 46. The agent bus 47, which may be a bi-directional bus, may be coupled with system interface 46, with the system interface 46 providing an interface through which the management agent 18 may communicate with the host system. In some embodiments, the management agent 18 may also include a System Management Mode (SMM) module (not shown) coupled with agent bus 47. The SMM module may be any combination of elements that provide SMM functionality to the host system.

In some embodiments, the connection between management agent 18 and network 16 is maintained for management and/or diagnostic purposes when the platform 12 is otherwise isolated from the network 16. That is, the platform 12 under control of the operating system 50 may be isolated from network 16, while the network connection of the OOB communication channel 20, that is independent of the operating system 50, is maintained. The secondary network interface 38 may provide the network connection for the management agent 18 that is independent of the operating system 50 and the primary network interface 36 of the host system. In summary, the management agent 18 may perform manageability, security and/or other functions in a secure manner transparent to the operating system 50.

The management agent 18 and the ICH 32 may operate to prevent communications with the network 16, for example, by disabling the primary network interface 36. This has been previously described as the network circuit breaker function. In some embodiments, code from the dynamic memory 45 may be executed by the controller 42 to achieve the network circuit breaker function by generating a triggering signal. In some embodiments, in response to this triggering signal, actions may be taken to logically disable Peripheral Component Interconnect (PCI) devices to prevent communications with other remote devices on the network 16. One example would be to disable the primary network interface 36, which may be a network controller. While PCI devices are used as specific examples, the network circuit breaker function may be applied to, for example, other platform buses that have hardware-based (register-based) enable/disable methods, or other logical, or extended system buses that can be disabled through control of appropriate configuration registers (e.g., USB buses or hubs, IEEE 1394 hubs). The PCI Special Interest Group of Portland, Oreg. manages the various PCI standards. Specific PCI standards and versions are discussed in greater detail below. IEEE 1394 interfaces and communication are described in an IEEE document entitled, “1394: Open Host Controller Interface Specification” Release 1.1, Jan. 6, 2000 as well as related and subsequent documents (e.g., IEEE 1394b).

In some embodiments, using a PCI compliant bus, the controller 42 of the management agent 18 may generate the triggering signal by writing a zero value a PCI Command register (not shown) of the primary network interface 36 to disable it. Setting the register with this value may disable the ability of the primary network interface 36 to respond to PCI read/write/configuration cycles and interrupts effectively disabling the device. The PCI Local Bus Specification, Revision 2.3 published Mar. 29, 2002 as well as the PCI Express Base Specification, Version 1.0 published Jul. 23, 2002 and Version 1.0a published Oct. 7, 2003 define the PCI Command register of devices conforming to these specifications. Subsequent and related standards may also define a Command register or equivalent that can be used as described herein. Subsequent and related PCI standards include, for example, PCI-Express, PCI-X, and PCI-AS (Advanced Switching). The description herein generically refers to all PCI standards mentioned or developed in the future that include a Command register or comparable functionality. In some embodiments, a USB hub coupled with a PCI-compliant bus may be disabled using the techniques described. When the USB hub has been disabled, all USB-compliant devices coupled with the hub are disabled. Thus, if a network interface is USB-compliant, the network interface can be disabled by writing a value (triggering signal) to a PCI Command register.

Communication with the network 16 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc. Further, these different communication possibilities may each have associated throughput characteristics and costs and may be used at least in part by policies to control how updates are received and applied to a platform 12.

In some embodiments, the processor 30 may be any type of processor known in the art, for example, a processor from the Pentium® family of processors, the Itanium® family of processors, or the Xeon™ family of processors, available from Intel Corporation of Santa Clara, Calif. In other embodiments, the processor 30 may be another brand of processor, an Application Specific Integrated Circuit (ASIC), controller, micro-controller, etc.

In some embodiments, the management agent 18 may be coupled with the processor 30 via an interrupt interface with, for example, a system management interrupt (SMI) pin of the Pentium® processor or with a platform management interrupt (PMI) pin of the Itanium® processor (generically, via line 102 in FIG. 1). Other system interrupt signals may be used for other processors. In some embodiments, the management agent 18 may be a mechanism that enables executable content in the form of one or more software drivers to be loaded into the System Management Mode (SMM) of an Intel 32-bit family of microprocessor (i.e., IA-32 processors), or the native mode of an Itanium-based processor with PMI signal activation. The state of execution of code in IA32 SMM is initiated by the SMI signal and that in Itanium-based processors is initiated by PMI signal activation; for simplicity, these will generally be referred to as SMM. In other embodiments, this interrupt feature may be used to provide updates from the non-volatile memory 44.

In some embodiments, the MCH 24 and ICH 32 may be part of a hub or core chipset. The chip set may be one or more integrated circuit chips that act as a hub or core for data transfer between the processor 30 and other components of the platform 12. In some embodiments, the MCH 24 may perform multiple functionalities such as an isolated execution mode, host-to-peripheral bus interface, and memory control of the memory subsystem 26 and mass storage 28 and the ICH 32 may control, for example, the input-output devices, such as the peripheral I/O devices 34 and the primary network interface 36. In some embodiments, the platform 12 may also contain additional components, such as other input-output devices (e.g., keyboard, mouse, display screen, printer, etc. or any combination of thereof), one or more co-processors, modem, etc.

While the platform 12 is described as having a single processor 30, multiple processor embodiments may also be supported. Although the processor 30 is shown coupled by a bus line to the MCH 24, in an alternate embodiment, processor 30 may be coupled with the MCH 24 by a shared system bus. MCH 24 may provide an interface to the memory subsystem 26. As previously defined, the network 16 may be any type of network, whether wired or wireless, for example, a local area network or a wide area network.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

1. A method for updating software of a platform having a dormant state and an active state, comprising:
receiving at least one software update with a secondary network interface of the platform during the dormant state;
caching the at least one software update during the dormant state in a non-volatile memory of the platform; and
installing the at least one software update on the platform with an updating software agent of the platform after the platform transitions from the dormant state to the active state and before a primary network interface of the platform is enabled.

2. The method according to claim 1, wherein the installing of the at least one software update with the updating software agent includes installing the at least one software update upon the booting up of the platform.

3. The method according to claim 1, further comprising:
booting up the platform with a boot routine of the platform to initiate the active state; and
loading the updating software program with the boot routine.

4. The method according to claim 1, further comprising:
after the installing of the at least one software update, providing from the platform in a peer-to-peer communication the at least one software update.

5. The method according to claim 1, further comprising:
after the installing of the at least one software update, providing by the platform of the at least one software update to an out-of-date platform.

6. The method according to claim 1, further comprising:
after the installing of the at least one software update, searching with a peer-to-peer program of the platform for another platform.

7. The method according to claim 6, wherein the searching with the peer-to-peer program for the another platform includes establishing a peer-to-peer connection with the another platform.

8. The method according to claim 7, further comprising:
after establishing the peer-to-peer connection, determining with the peer-to-peer program that the another platform does not have the at least one software update; and
providing by the platform of the at least one software update to the another platform.

9. The method according to claim 1, further comprising:
monitoring with a management agent of the platform having the secondary network interface for receipt of the at least one software update during at least the dormant state.

10. The method according to claim 1, further comprising:
monitoring with a management agent of the platform having the secondary network interface for receipt of the at least one software update during the dormant state and the active state.

11. A method for updating software of an out-of date platform having a dormant state and an active state, comprising:
disabling a primary network interface of the out-of-date platform in response to a disabling circuit breaker signal received by way of a secondary network interface of the out-of-date platform;
receiving by way of the secondary network interface in a peer-to-peer communication at least one software update; and
installing the at least one software update in the out-of-date platform.

12. The method according to claim 11, further comprising:
after installing the at least one software update, requesting by way of the secondary network interface an enabling circuit breaker signal to enable the primary network interface.

13. The method according to claim 12, further comprising:
enabling the primary network interface in response to receiving the enabling circuit breaker signal; and
communicating over the primary network interface of the platform after the at least one software update is installed.

14. The method according to claim 13, wherein
the disabling of the primary network interface in response to the disabling circuit breaker signal includes disabling the primary network interface in response to the disabling circuit breaker signal received from a network administrator;
the requesting by way of the secondary network interface of the enabling circuit breaker signal includes requesting that the enabling circuit breaker signal be transmitted from the network administrator; and
the enabling of the primary network interface in response to receiving the enabling circuit breaker signal includes enabling the primary network interface in response to receiving the enabling circuit breaker signal from the network administrator.

15. The method according to claim 11 wherein the disabling of the primary network interface of the out-of-date platform in response to the disabling circuit breaker signal includes the disabling circuit breaker signal being generated in response to the software being out-of-date.

16. A platform having an active and a dormant state, comprising:
a primary network interface and a mass storage;
a management agent including a secondary network interface to receive a software update at least during the dormant state and further including a non-volatile memory coupled to the secondary network interface to cache the software update;
a memory subsystem to contain an updating software agent;
a processor, coupled to the memory subsystem, the mass storage, the non-volatile memory and the primary network interface, to execute the updating software agent and to install the software update after the platform transitions from the dormant state to the active state and before the primary network interface is communicatively enabled.

17. The platform according to claim 16, wherein the primary network interface is adapted to be communicatively enabled after the software update is installed.

18. The platform according to claim 16, wherein the memory subsystem is further adapted to contain a boot routine; and the processor is adapted to execute the boot routine to initiate the active state.

19. The platform according to claim 16, wherein the platform is further adapted to provide the software update to an out-of-date platform.

20. The platform according to claim 16, wherein the management agent further includes a network circuit breaker routine, responsive to a disabling circuit breaker signal received from the secondary network interface, to disable the primary network interface from being communicatively enabled.

21. The platform according to claim 16, wherein the management agent further includes a network circuit breaker routine, responsive to a disabling circuit breaker signal received from a network administrator by way of the secondary network interface, to disable the primary network interface from being communicatively enabled.

22. The platform according to claim 20, wherein a selected one of the primary and the secondary network interfaces is adapted to receive the software update in a peer-to-peer communication.

23. The platform according to claim 22, wherein the management agent is adapted to request an enabling circuit breaker signal in response to installing the software update received in the peer-to-peer communication.

24. The platform according to claim 16, wherein the primary network interface is communicatively coupled to a network during the active state and the secondary network interface is communicatively coupled to the network at least during the dormant state.

25. The platform according to claim 16, wherein the software update includes a selected one of a software patch to update an existing software program or a replacement program to replace the existing software program.

26. An article comprising a machine-readable medium that contains instructions for updating software of a platform having a dormant state and an active state, which when executed by the platform, cause the platform to perform operations comprising:
receiving at least one software update with a management agent implemented by the instructions by way of a secondary network interface of the platform during the dormant state;
caching the at least one software update with the management agent in a non-volatile memory of the platform during the dormant state; and
installing the at least one software update on the platform with an updating software agent of the platform after the platform transitions from the dormant state to the active state and before a primary network interface of the platform is enabled.

27. The article according to claim 26, wherein the installing of the at least one software update with the updating software agent includes installing the at least one software update upon the booting up of the platform.

28. The article according to claim 26, wherein the operations further comprise:
after the installing of the at least one software update, providing by the management agent in a peer-to-peer connection the at least one software update from the platform to an out-of-date platform.

29. The article according to claim 26, wherein the operations further comprise:
monitoring with the management agent for receipt of the at least one software update during at least the dormant state.

30. An article comprising a machine-readable medium that contains instructions for updating software of an out-of date platform having a dormant state and an active state, which when executed by the platform, cause the out-of-date platform to perform operations comprising:
disabling a primary network interface of the out-of-date platform in response to a disabling circuit breaker signal received by way of a secondary network interface of the out-of-date platform;
receiving by way of the secondary network interface in a peer-to-peer communication at least one software update; and
installing the at least one software update in the out-of-date platform.

31. The article according to claim 30, wherein the operations further comprise:
after installing the at least one software update, requesting by way of the secondary network interface an enabling circuit breaker signal to enable the primary network interface.

32. The article according to claim 31, wherein the operations further comprise:
enabling the primary network interface in response to receiving the enabling circuit breaker signal; and
communicating over the primary network interface of the platform after the at least one software update is installed.

33. The article according to claim 33, wherein
the disabling of the primary network interface in response to the disabling circuit breaker signal includes disabling the primary network interface in response to the disabling circuit breaker signal received from a network administrator;
the requesting by way of the secondary network interface of the enabling circuit breaker signal includes requesting that the enabling circuit breaker signal be transmitted from the network administrator; and
the enabling of the primary network interface in response to receiving the enabling circuit breaker signal includes enabling the primary network interface in response to receiving the enabling circuit breaker signal from the network administrator.

34. The article according to claim 30, wherein the disabling of the primary network interface of the out-of-date platform in response to the disabling circuit breaker signal includes the disabling circuit breaker signal being generated in response to the software being out-of-date.
